(19) United States
(12) Patent Application Publication
(10) Pub. No.: US 2026/0050730 A1
(43) Pub. Date: Feb. 19, 2026

(54) DESIGN FOR MANUFACTURABILITY (DFM) STRUCTURES FOR DETECTION OF OVERLAY SHIFTS IN FABRICATION PROCESS SYSTEMS AND METHODS

(71) Applicant: pSemi Corporation, San Diego, CA (US)

(72) Inventors: Arpita Moghe Chadha, San Diego, CA (US); Shishir Ray, San Diego, CA (US); Chris O'Brien, San Diego, CA (US); Keith Rampmeier, San Diego, CA (US); Tran Ngoc Kononova, San Diego, CA (US); Alexander Shtam, San Diego, CA (US)

(21) Appl. No.: 18/805,468

(22) Filed: Aug. 14, 2024

(51) Int. Cl. G06F 30/398; G06F 115/02; G06F 119/18; H01L 21/66

(52) U.S. Cl. CPC G06F 30/398; H01L 22/12; H01L 22/26; G06F 2115/02; G06F 2119/18

(57) ABSTRACT

Systems and methods for using a design for manufacturing (DFM) structure to detect an overlay shift. The DFM structure comprises four branches with transistors and switches connected to a switch control. The first branch measures a current-voltage characteristic corresponding to the overlay shift in a first direction using a first switch. A second branch measures the current-voltage characteristic corresponding to the overlay shift in a second direction using a second switch. A third branch measures the current-voltage characteristic corresponding to the overlay shift in a third direction using a third switch. A fourth branch measures the current-voltage characteristic corresponding to the overlay shift in a fourth direction using a fourth switch. The switches are connected to a switch control configured to active each of the switches to measure the current-voltage characteristic, such that the value of the current-voltage characteristic indicates an overlay shift in an integrated circuit of a die.

### TECHNICAL FIELD

The disclosure generally relates to identifying defective dies, and more specifically to identifying defective dies using design for manufacturability structures.

### BACKGROUND

A die is a portion of a wafer that includes an integrated circuit. A wafer may include multiple dies. Conventionally the integrated circuit in each die is tested using an ink out process. In this process, the integrated circuit is tested using electrical testing, such as circuit probe or wafer sort testing. The defective dies, which may include bad or failing integrated circuits are marked with ink on the wafer, or are recorded in a log file or a digital wafer file that represents a location of the dies in the wafer.

Additionally, one or more outlier detection tests may be employed to identify dies with integrated circuits that have passed the electrical testing process, but that are likely to fail in the field. One test may compare the electrical testing results of multiple wafers and statistically predict the dies that are likely to fail. Another technique may use algorithms to evaluate proximity or severity of the failed integrated circuits or integrated circuits clusters, and then predict additional dies with integrated circuits that may fail. In another example, as defective integrated circuits are known to occur at an edge of a wafer, a blanket rejection may be used to reject the dies within predefined distance from the edge. The dies that are likely to fail are also marked with ink on the wafer, or are recorded in the log file or the digital wafer file that represents a location of the dies in the wafer.

The above conventional processes result in an over-rejection of good dies because the processes may over-reject good dies that may statistically be indicated as being progressively defective.

### BRIEF DESCRIPTION OF THE DRAWINGS

FIG. 1A is an exemplary diagram illustrating a wafer, according to some embodiments.

FIG. 1B is an exemplary diagram of a digital wafer file, according to some embodiments.

FIGS. 2A-C illustrate a wafer with defective dies and dies identified as progressively defective dies, according to some embodiments.

FIGS. 3A-B are diagrams of design for manufacturability (DFM) structures, according to some embodiments.

FIGS. 4A-B are diagrams of a layout of DFM structures, according to some embodiments.

FIG. 5 is a flowchart of a method for generating DFM structures in a die, according to some embodiments.

FIG. 6 is a flowchart of a method for identifying a defective die using DFM structures, according to some embodiments.

FIG. 7 is a block diagram of a test multiplexor in an integrated circuit of a die, according to some embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Design for manufacturing (DFM) structures are used to augment or enhance insight into integrated circuit manufacturing process. The DFM structures may be included in an integrated circuit and may be located within a process control monitor (PCM) cell of the integrated circuit. The DFM structures that identify shift overlays or process shifts. To identify shift overlays or process shifts, the DFM structures may be specifically designed to be more sensitive to current variation than the integrated circuit itself. For example, the DFM structures may have a sub-minimum layout that may violate minimum predefined spacing in the circuit. Example spacing may be a poly-to-contact spacing, where a contact is a drain contact or source contact, or a poly-to-active area spacing.

The embodiments are directed to the DFM structures that may detect a defective integrated circuit or a failing integrated circuit due to shift overlays or process shifts. The embodiments are also directed to DFM structures that identify a direction of the defective or progressively defective integrated circuit by analyzing current-voltage characteristics in multiple directions, such as directions along the x-y axes. The directions may be along a positive and negative x-direction, and along a positive and negative y-direction, thus providing a 360 degree coverage for identifying defective and progressively defective dies in the integrated circuit.

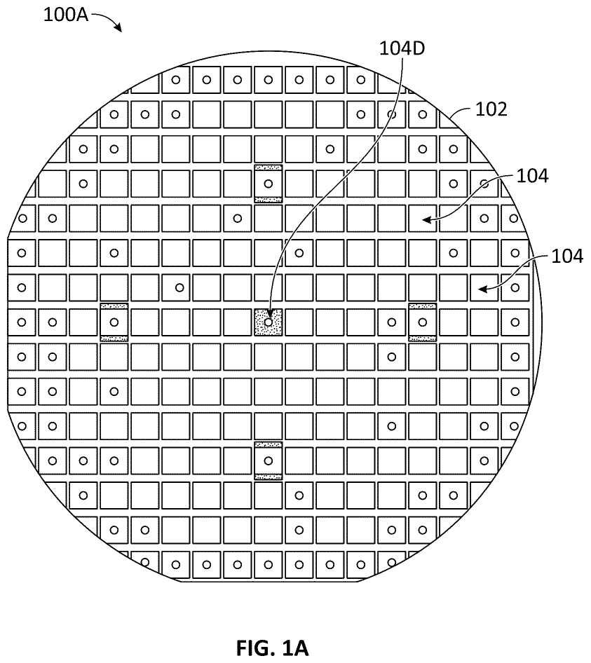

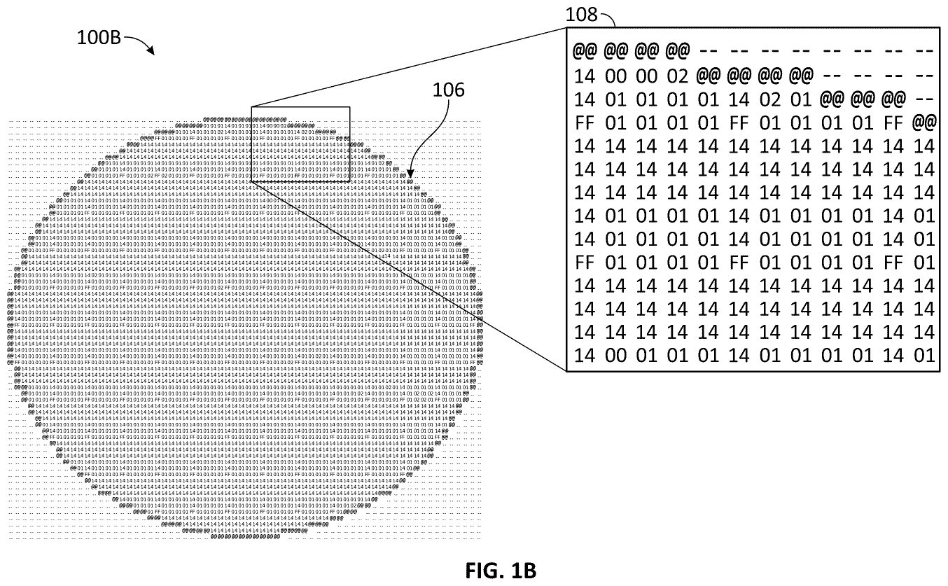

FIG. 1A is an exemplary diagram 100A illustrating a wafer, according to some embodiments. A wafer 102 in FIG. 1A may be divided into multiple dies 104. Each die 104 may include an integrated circuit, such as a chip. Typically, dies 104 may be cut from wafer 102 using a saw into individual dies 104 that may be shipped to customers.

Prior to cutting the dies 104 from wafer 102, dies 104 may be electrically tested to identify good and defective dies. In a conventional approach, the defective dies may be marked with ink, as shown by die 104D, and then removed after wafer 102 is cut into dies 104. In addition to the defective dies, outlier detection tests may be performed on the dies to statistically identify progressively defective or failing dies. Progressively defective or failing dies may be dies that passed an electrical test, but are likely to fail in the field. Progressively defective or failing dies may also be marked with ink.

FIG. 1B is an exemplary diagram 100B of a digital wafer file, according to some embodiments. A digital wafer file 106 may track good and defective dies in wafer 102. To track good and defective dies, digital wafer file 106 may be aligned with wafer 102 and may include multiple digits 108 that correspond to locations of dies 104 in wafer 102. Each digit 108 may be set to an alphanumeric value or a symbol. The alphanumeric value may initially be set to a default value. Once an electrical test is executed for a particular die 104, the value may be set to indicate that die 104 is a good die or a defective die. In some embodiments, the default values may indicate good dies, and may be switched when the electric test indicates that that die 104 is a defective die. Once dies 104 of wafer 102 complete the electric test, and are marked as good dies or defective dies using digits 108 in the digital wafer map 106, the digital wafer map 106 may represent the good and defective dies 104 in wafer 102. In some embodiments, dies 104 that are identified as progressively defective dies may also be marked in digital wafer file 106, using the same or different alphanumeric value or a symbol as the defective dies.

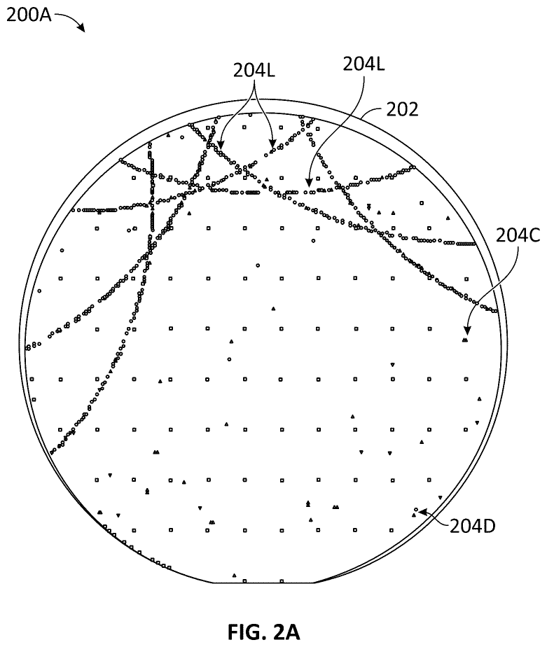

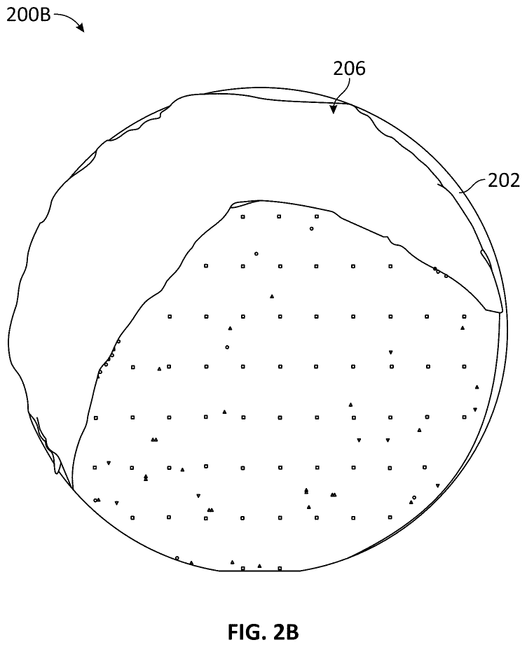

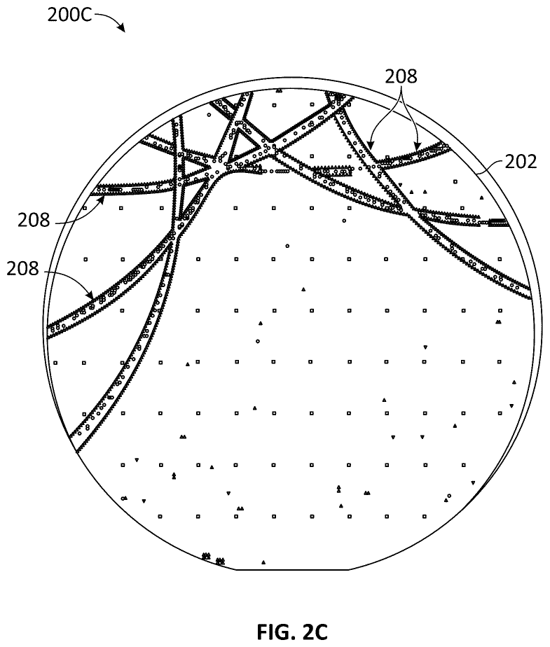

FIG. 2A is a diagram 200A illustrating a digital wafer map representing good and defective dies, according to some embodiments. A digital wafer map 202 in FIG. 2A may represent wafer 102 discussed in FIG. 1A or another wafer that has undergone electric testing on individual dies 104. The defective dies 104D may be illustrated as dies 204, that may form curved lines 204L, be individual defective dies 204D, or may form clusters of defective dies 204C.

As discussed above, conventional techniques may identify defective dies 104D marked using ink on wafer 102 or on digital wafer map 202 and progressively failing dies that may have passed the electrical tests but have a high likelihood of failing in the future. Further, the conventional techniques may be overinclusive in statistically predicting progressively defective or failing dies. FIG. 2B is a diagram 200B illustrating a digital wafer map representing good, defective and progressively defective dies identified using a conventional technique. The conventional technique may identify an over-inclusive cluster 206 of defective and progressively defective dies based on digital wafer map 202 of FIG. 2A. Cluster 206 illustrates an over-inclusive nature of the conventional techniques that typically include a blanket ink-out of dies 104 that may be good dies but statistically may be designated as failing dies. Such blanket ink-out leads to an increased overall cost of manufacturing dies and lower yield of good dies 104 from wafer 102.

Further, defective and progressively defective dies often occur around an edge of waver 102. This leads to conventional techniques creating a blanket ink-out of sections of wafer 102 around the edge of wafer 102 (not shown).

In some embodiments, design for manufacturing (DFM) structures may be incorporated into the integrated circuits to identify defective and progressively defective (or failing) dies. Unlike conventional techniques, DFM structures may identify defective and progressively defective dies on a granular level, such as on per die basis. This is because the DFM structures may be incorporated into an integrated circuit of each die. FIG. 2C is a diagram 200C illustrating a digital wafer map representing defective and failing dies identified using DFM structures, according to some embodiments. As illustrated in FIG. 2C, digital wafer map 202 includes defective dies shown in FIG. 2A and failing dies 208 identifies using DFM structures. Compared to the blanket ink-out shown in FIG. 2B, the benefits of using DFM structures are obvious as DFM structures allow for a more granular approach in identifying defective and failing dies 104. This in turn increases an overall yield of the dies that may be shipped to customers from wafers 102.

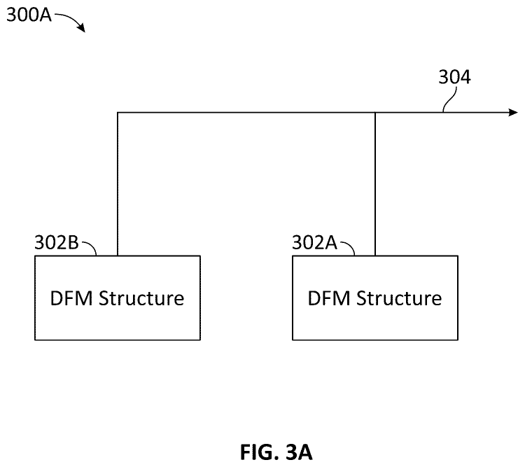

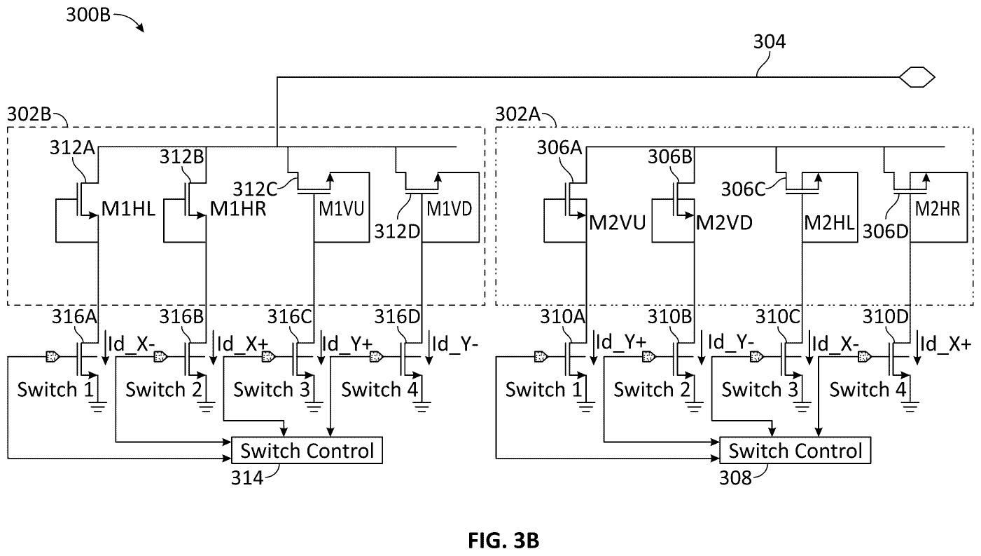

FIG. 3A is a block diagram 300A of DFM structures, according to some embodiments. FIG. 3A illustrates two DFM structures 302, such as DFM structures 302A and 302B. DFM structures 302A-B may be included within an integrated circuit of each die in dies 104. In some instances, DFM structures 302 may be included in a process control monitor (PCM) cell within each die in dies 104. Notably, an implementation is not limited to this embodiment, and there may be one or multiple DFM structures 302 in each integrated circuit, where each DFM structure 302 may identify a certain type of defect or a progressive failure. Because DFM structures 302 may be included in an integrated circuit, DFM structures 302 may increase resolution for determining defective and failing dies. Specifically, while conventional techniques may perform 5-9 measurements per wafer, the DFM structures may perform thousands, and even hundreds of thousands of measurements. Moreover, unlike conventional techniques, DFM structures 302 may facilitate measurements at an edge or near the edge of wafer 102, such as less than 10^{th} of millimeters from the edge of wafer 102.

In some embodiments, the output of one or more DFM structures 302 may be combined to indicate that there is a defective or failing die when one or more DFM structures 302 identify a failure. Additionally, as will be explained below, DFM structures 302 may identify a defect in dies 104 in multiple directions, such as in a positive and negative x direction and in a positive and negative y direction along the x-y axes.

In some embodiments, the DFM structures 302 may identify progressive failure due to overlay shifts that may be in an integrated circuit. To identify progressive failure in dies, DFM structures 302 may be specifically designed to be more sensitive to current variation than the integrated circuit, allowing DFM structures 302 to identify current variations at a more granular level. Such design may include a sub-minimum layout in DFM structure 302 that may violate minimum predefined spacing in the integrated circuit.

As discussed above, DFM structures 302 may be designed to identify different types of defects and progressive defects. For example, DFM structure 302A may measure an overlay shift in a poly-to-contact spacing, where the contact is a drain contact or a source contact. The overlay shift in the poly-to-contact spacing may cause yield loss in severe cases, such as an error of 110 nm or more, and potential progressive failure in marginal cases, such as an error between 60-110 nm. The spacing shift may cause the transistor source or drain contact to run into the gate poly creating a shorted device. Accordingly, DFM structure 302A may be designed with sub-design rule features to cause leakage during a marginal shift or an error during the fabrication process. An example feature may be spacing between a gate poly and a source or drain contact as 55 nm. The spacing may be determined using statistical data to catch shifts before the shift may cause progressive failures in an integrated circuit in the field due to a variety of reasons, such as high temperature, high voltage and the like.

In another example, DFM structure 302B may measure an overlay shift in a poly-to-active area spacing. The poly-to-active area overlay that has an error that is greater than 70 nm may cause formation of parasitic FET between neighboring devices, that is undetectable in the production test, but can cause high voltage that causes failures in the field. Accordingly, DFM structure 302B may be designed with sub-design rule features that cause leakage during a marginal shift or error during fabrication. An example feature may be a poly overhang on an active area as 66 nm, and may be determined using statistical data to catch shifts before the shift may cause progressive failures in integrated circuits in the field due to high temperature, voltage, etc.

In some embodiments, DFM structures 302, including DFM structures 302A-B, may identify an overlay shift in any direction along the x-y axes, such as along the positive and negative x direction, and a positive and negative y direction. This way, DFM structures 302 may provide a three hundred and sixty degree coverage in detecting overlay shifts. FIG. 3B is a diagram 300B illustrating the internal circuity of DFM structures, according to some embodiments.

FIG. 3B is a diagram 300B of an internal circuitry of DFM structures, according to some embodiments. FIG. 3B illustrates an internal structure of DFM structure 302A and DFM structure 302B. DFM structure 302A may include four branches, where each branch includes one transistor and one switch, such as one of transistors 306A-D and one of switches 310A-D. Each transistor in transistors 306A-D has a sub-minimum gate to drain or gate to source contact spacing (e.g., 55 nm) created to detect process shifts in a corresponding direction. To detect process shifts, each of transistors 306A-D may measure a current-voltage characteristic in the corresponding direction. For example, transistor 306A may measure a current-voltage characteristic in a vertical up direction, e.g., along a positive y direction in the x-y axes, transistor 306B may measure a current-voltage characteristic in a vertical down direction, e.g., along a negative y direction in the x-y axes, transistor 306C may measure a current-voltage characteristic in a horizontal left direction, e.g., along a positive x direction in the x-y axes, and transistor 306D may measure a current-voltage characteristic in a horizontal right direction, e.g., positive x direction in the x-y axes.

In some embodiments, transistors 306A-D may be n-mos transistors, that include a drain, a source, and a gate. The gate and the source of each one of transistors 306A-D is shorted, such that each one of transistors 306A-D is by default in an off state. In this embodiment, an example current-voltage characteristic may be current, that may be a baseline current across transistors 306A-D when there is no overlay shift. However, when there is an overlay shift, the one or more transistors may act as a resistor, which increases the value of the baseline current by several factors, depending on the severity of the overlay shift.

Each of transistors 306A-D in the respective branch may be connected to a switch, such as one of switches 310A-D. For example, in the first branch, transistor 306A may be connected to switch 310A, in the second branch, transistor 306B may be connected to switch 310B, in the third branch, transistor 306C may be connected to switch 310D, and in the fourth branch, transistor 306D may be connected to switch 310D. Switches 310A-D may also be n-mos transistors. Switches 310A-D may be connected to switch control 308. Switch control 308 may turn switches 310A-D on and off to measure a current-voltage characteristic in a corresponding branch. When switches 306A-D are turned on, current begins to flow through transistors 306A-D and through switches 310A-D. The value of the current may be output 304 that flows through drains of transistors 306A-D, and may correspond to the current-voltage characteristic. Output 304 may be connected to a pin, such as a pin in a PCM cell, and may be measured at the pin. In some instances, the drains of transistors 310A-D may be connected to generate a single output 304. Based on the value of the current-voltage characteristic at the pin, an overlay shift is detected, and based on the transistor in transistors 306A-D that generated the current-voltage characteristic, the direction of the overlay shift is determined. Further, based on DFM structure 302, such as DFM structure 302A or 302B, that generated the current-voltage characteristic, a type of an overlay shift is determined.

In some embodiments, switch control 308 may activate (or turn on) and deactivate (or turn off) switches 310A-D. To activate and deactivate switches 310A-D, switch control 308 may be connected to gates of switches 310A-D.

In one embodiment, switch control 308 may turn switches 310A-D sequentially. For example, switch control 308 may turn switch 310A to measure the current passing through transistor 306A and based on a value of the current, existence of an overlay shift in a vertical up direction may be determined. Next, switch control 308 may turn switch 310B to measure the current passing through transistor 306B and based on the value of the current, existence of an overlay shift in a vertical down direction may be determined. Next, switch control 308 may turn switch 310C to measure the current passing through transistor 306C and based on the value of the current, existence of an overlay shift in a horizontal left direction may be determined. Finally, switch control 308 may turn switch 310D to measure the current passing through transistor 306D and based on the value of the current, existence of an overlay shift in a horizontal down direction may be determined. Notably, the order that switch control 308 may turn on switches 306A-D may be arbitrary.

In another embodiment, switch control 308 may turn switches 310A-D in parallel to measure the current in parallel across transistors 306A-D. If the current indicates an existence of an overlay shift, switch control 308 may turn switches 310A-D sequentially to determine the direction of the overlay shift. If the current indicates that an overlay shift does not exist, the test may be performed using a different DFM structure 302, such as DFM structure 302B, without performing a sequential analysis.

DFM structure 302B may include four branches, where each branch includes one transistor and one switch, such as one of transistors 312A-D and one of switches 316A-D. Each transistor 312A-D has a one finger with sub-minimum poly overhang (66 nm) created to detect process shifts. To detect process shifts, transistors 312A-D may measure a current-voltage characteristic in a particular direction. For example, transistor 312A may measure a current-voltage characteristic in a horizontal left direction, e.g., along a negative x direction in the x-y axes, transistor 312B may measure a current-voltage characteristic in a horizontal right direction, e.g., along a positive x direction in the x-y axes, transistor 312C may measure a current-voltage characteristic in a vertical up direction, e.g., along a positive x direction in the x-y axes, and transistor 312D may measure a current-voltage characteristic in a vertical down direction, e.g., negative y direction in the x-y axes.

In some embodiments, transistors 312A-D may be n-mos transistors, that include a drain, a source, and a gate. The gate and the source of each one of transistors 312A-D is shorted, such that each one of transistors 312A-D is by default in an off state. As discussed above, an example current-voltage characteristic may be current across transistors 312A-D. The current may be a base-line current when there is no process shift. However, when there is a process shift, the one or more transistors 312A-D may act as a resistor, thus increases the value of the baseline current by several factors, depending on the severity of the poly overhang.

Each of transistors 312A-D in the respective branch may be connected to a switch, such as switches 316A-D. For example, in the first branch, transistor 312A may be connected to switch 316A, in the second branch, transistor 312B may be connected to switch 316B, in the third branch, transistor 312C may be connected to switch 316C, and in the fourth branch, transistor 312D may be connected to switch 316D. Switches 316A-D may also be n-mos transistors. Switches 316A-D may be connected to switch control 314. Switch control 314 may turn switches 316A-D on and off to measure a current-voltage characteristic in a corresponding branch. When switches 316A-D are turned on, current begins to flow through transistors 312A-D and through switches 316A-D. The value of the current may be output 304 that flows through drains of transistors 306A-D, and may correspond to the current-voltage characteristic.

In some embodiments, switch control 314 may activate and deactivate switches 316A-D. To activate and deactivate switches 316A-D, switch control 308 may be connected to gates of switchers 316A-D.

In one embodiment, switch control 314 may turn switches 316A-D sequentially. For example, switch control 314 may turn switch 316A to measure the current passing through transistor 312A and determine existence of a process shift in a horizontal left direction. Next, switch control 314 may turn switch 316B to measure the current passing through transistor 312B and determine existence of a process shift in a horizontal right direction. Next, switch control 314 may turn switch 316C to measure the current passing through transistor 312C and determine existence of a process shift in a vertical up direction. Finally, switch control 314 may turn switch 316D to measure the current passing through transistor 312D and determine existence of a process shift in a vertical down direction. Notably, the order that switch control 314 may turn on switches 306A-D may be arbitrary.

In another embodiment, switch control 314 may turn switches 316A-D in parallel to measure current in parallel across transistors 312A-D. If the current indicates an existence of a process shift, switch control 314 may turn switches 316A-D sequentially to determine the direction of the process shift. If the current indicates that the process shift does not exist, the test may be performed using a different DFM structure 302 without performing a sequential analysis.

In some instances, the drains of transistors 306A-D and 312A-D may be connected to output 304. In this way, branches that include transistors 306A-D and 312A-D may be turned on sequentially to generate output 304, which is measured at the pin in the PCM cell. In some instances, switch controls 308 and 314 may turn transistors 306A-D and 312A-D in parallel to determine an existence of an overlay or process shift in one or both DFM structures 302A-B, and if an overlay or process shift exists, turns transistors 306A-D and 312A-D sequentially.

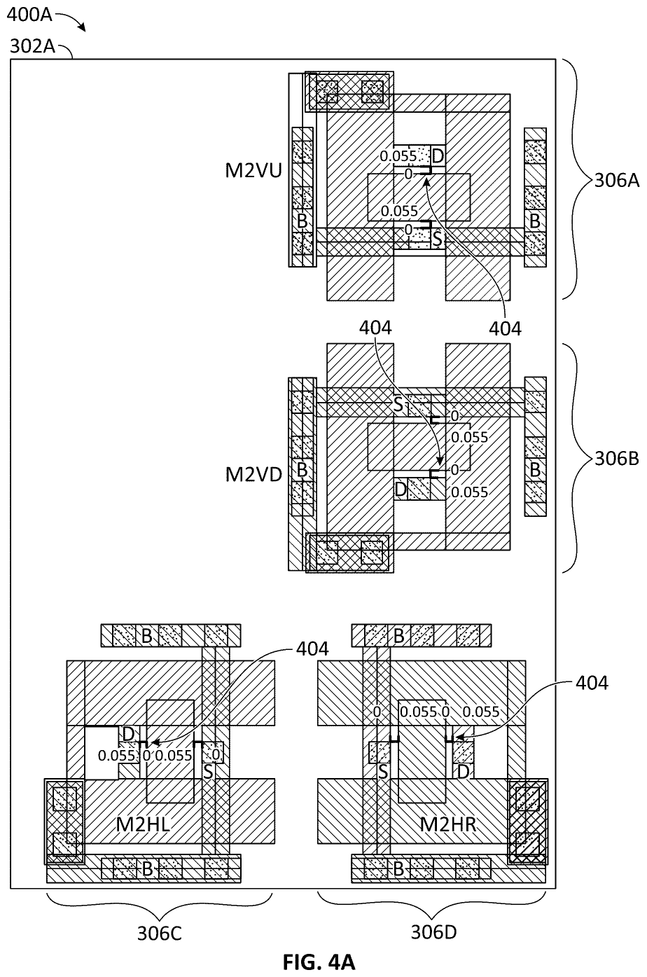

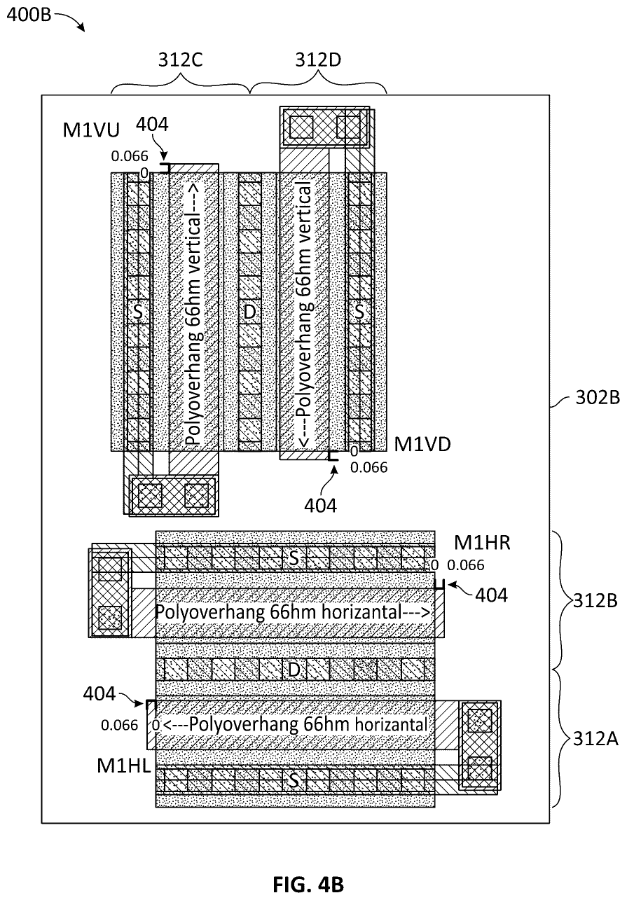

FIGS. 4A-4B are diagrams 400A-B of a layout of DFM structures, according to some embodiments. FIG. 4A illustrates a diagram 400A of DFM structure 302A that measures an overlay shift in a poly-to-contact spacing, using transistors 306A-D. Transistors 306A-D measure the overlay shift in the four directions along the x-y axes. For example, transistors 306A and 306B measure the overlay shift in the positive and negative directions along the y axis, and transistors 306C and 306D measure the overlay shift along the positive and negative directions along the x axis. The layout of transistors 306A-D, that are n-mos transistors is illustrated with the spacing 404 that is 55 nm between the poly and source, and poly and drain contracts.

FIG. 4B illustrates a diagram 400B of DFM structure 302B that measures a process shift in a poly-to-active area, using transistors 312A-D. Transistors 312A-D measure the process shift in the four directions along the x-y axes. For example, transistors 312A and 312B measure the process shift in the negative and positive directions along the x axis, and transistors 312C and 312D measure the overlay shift along the positive and negative y axis. The layout of transistors 312A-D, that are n-mos transistors is illustrated with the spacing 406 that is 66 nm between the poly and the active area.

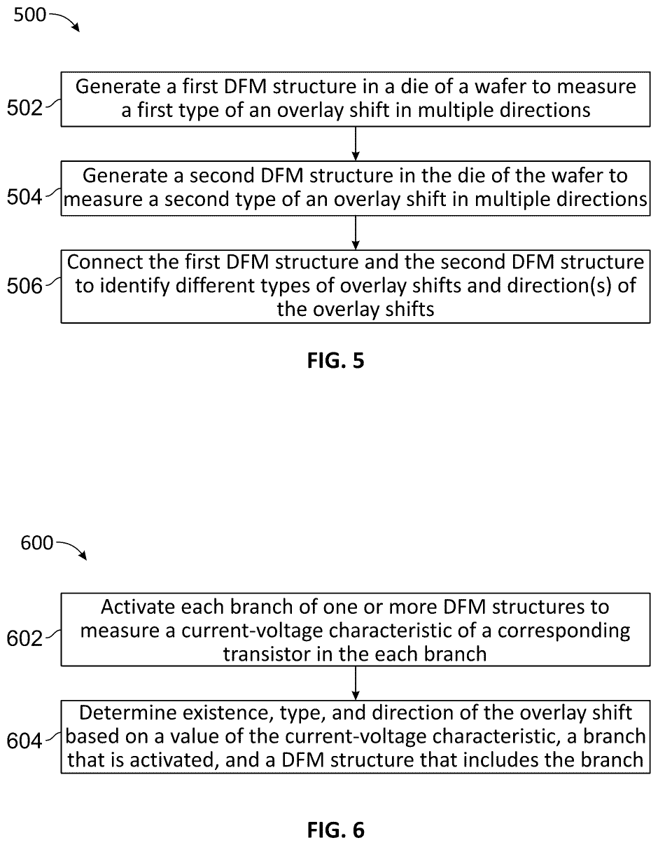

FIG. 5 is a flowchart of a method 500 for generating DFM structures, according to some embodiments. Notably, method 500 is exemplary and other methods may also be used. Method 500 may be performed using hardware and/or software components described in FIGS. 1-4A-B. Note that one or more of the operations may be deleted, combined, or performed in a different order as appropriate. Method 500 may be performed for each die 104 or a group of dies 104 in wafer 102.

At operation 502, a first DFM structure is generated. For example, DFM structure 302A may be generated and incorporated into each die 104 or a group of dies 104 in wafer 102. As discussed above DFM structure 302A includes four branches that may measure an overlay shift in the poly-to-contact spacing in the four different directions along the x-y axes. There may be one of transistors 306A-D and corresponding one of switches 310A-D that may be included in each branch, and switch control 308 that may turn the switches 310A-D on and off to measure the current-voltage characteristic caused by transistors 306A-D in each branch.

At operation 504, a second DFM structure is generated. For example, DFM structure 302B may be generated and incorporated into each die 104 or a group of dies 104 in wafer 102. As discussed above DFM structure 302B includes four branches that may measure an overlay shift in the poly-to-active area in the four different directions along the x-y axes. There may be one of transistors 312A-D and corresponding one of switches 316A-D that may be included in each branch, and switch control 314 that may turn the switches 316A-D on and off to measure the current-voltage characteristic caused by transistors 312A-D at each branch.

At operation 506, the first DFM structure and the second DFM structure is connected. For example, the drains of transistors 306A-D of DFM structure 302A and drains of transistors 312A-D of DFM structure 302B are connected together, such that output 104 generated by transistors 306A-D and transistors 312A-D may be measured at a single location, such as a pin in the PCM cell. As discussed above, the transistor in transistors 306A-D or transistors 312A-D that corresponds to an anomalous (e.g., high) current-voltage characteristic may correspond to a direction of the overlay or process shift and the DFM structure 302A or 302B may correspond to a type of a shift.

FIG. 6 is a flowchart of a method 600 for determining an overlay shift, according to some embodiments. Notably, method 600 is exemplary and other methods may also be used. Method 600 may be performed using hardware and/or software components described in FIGS. 1-4A-B. Note that one or more of the operations may be deleted, combined, or performed in a different order as appropriate.

At operation 602, each branch of a DFM structure is activated. For example, switch control 308 may activate switches 310A-D corresponding to transistors 306A-D in each branch of DFM structure 302A sequentially to determine a direction of the overlay shift in a poly-to-contact drain or source in die 104. In another example, switch control 314 may activate switches 316A-D corresponding to transistors 312A-D in DFM structure 302B sequentially to determine a direction of the process shift in a poly-to-active area in die 104. In some instances, switches 310A-D and switches 316A-D corresponding to transistors 306A-D and transistors 312A-D may be activated in parallel to determine existence of different types of overlay shifts along the x-y axes, and if an anomalous current-voltage characteristic exists, the switches 310A-D and switches 316A-D may be activated sequentially.

At operation 604, an overlay shift is determined. For example, as each of switches 310A-D and/or switches 316A-D are activated, the corresponding transistors 306A-D and/or transistors 312A-D generate output 104. Output 104 may be measured to determine the current-voltage characteristic. The value of the current-voltage characteristic may indicate an overlay or process shift, and the corresponding one of transistors 306A-D, 312A-D that generated output 104 may identify a direction of the overlay shift, and the corresponding DFM structure 302A-B determines a type of the overlay shift.

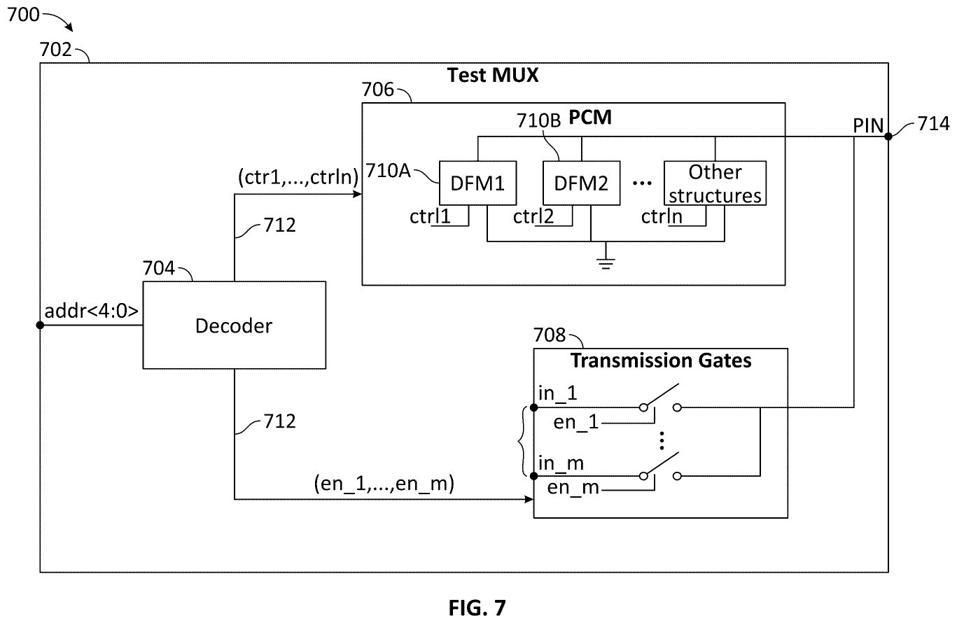

FIG. 7 is a block diagram of a test multiplexor in an integrated circuit of a die, according to some embodiment. FIG. 7 illustrates a test multiplexor or test mux 702 that is included in an integrated circuit of a die. In some instances, test mux 702 may be included in each die of a wafer. Test mux 702 includes a decoder 704, a PCM 706, and transmission gates 708. Decoder 704 may receive control signals from the integrated circuit, decode the control signals, and transmit the control signals to either PCM 706 or transmission gates 708 via bus 712. Control signals may indicate wither PCM 706 or transmission gates 708 are turned on. When PCM 706 is turned on, control signals indicate which of the one or more DFM structures 710 are turned on as well.

PCM 706 may include one or more DFM structures 710, such as DFM structure 710A and 710B. DFM structures 710 may include circuitry for testing anomalies within the die. Some DFM structures 710 may include DFM structures 302A and 302B for detecting an overlay shift in the poly-to-contact spacing and a poly-to-active area overlay. Other DFM structures 710 may include different circuits, resistor, transistors, etc., that are arranged in different ways to detect other anomalies. The output of DFM structures 710 that indicates an anomaly may be measured at pin 714.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A design for manufacturing (DFM) structure configured to detect an overlay shift, the DFM structure comprising:
a first branch configured to measure a current-voltage characteristic corresponding to the overlay shift in a first direction, wherein the first branch comprises a first transistor coupled to a first switch;
a second branch configured to measure the current-voltage characteristic corresponding to the overlay shift in a second direction, wherein the second branch comprises a second transistor coupled to a second switch;
a third branch configured to measure the current-voltage characteristic corresponding to the overlay shift in a third direction, wherein the third branch comprises a third transistor coupled to a third switch;
a fourth branch configured to measure the current-voltage characteristic corresponding to the overlay shift in a fourth direction, wherein the fourth branch comprises a fourth transistor coupled to a fourth switch; and
a switch control configured to activate the first switch, the second switch, the third switch or the fourth switch to measure the current-voltage characteristic in a corresponding branch, wherein a value of the current-voltage characteristic corresponds to an existence of the overlay shift in an integrated circuit of a die in a wafer and the corresponding branch indicates a direction of the overlay shift.

2. The DFM structure of claim 1, wherein the overlay shift is a poly-to-contact overlay shift.

3. The DFM structure of claim 1, wherein the overlay shift is a poly-to-active area overlay shift.

4. The DFM structure of claim 1, wherein the second direction is opposite of the first direction and wherein the third direction is opposite of the fourth direction.

5. The DFM structure of claim 1, wherein the first direction is a positive x direction, the second direction is a negative x direction, the third direction is a positive y direction, and the fourth direction is a negative y direction, and wherein the positive and negative x direction and the positive and negative y direction are along an x-y axes.

6. The DFM structure of claim 1, wherein the switch control is further configured to sequentially activate the first switch, the second switch, the third switch, and the fourth switch.

7. The DFM structure of claim 1,
wherein the switch control is further configured to activate the first switch, the second switch, the third switch, and the fourth switch in parallel to determine the existence of the overlay shift; and
based on determining the existence of the overlay shift, the switch control is further configured to activate the first switch, the second switch, the third switch, and the fourth switch sequentially to determine the direction of the overlay shift.

8. The DFM structure of claim 1, wherein the DFM structure is incorporated inside a process control monitor cell.

9. The DFM structure of claim 1, wherein the die with the overlay shift is marked in an electronic wafer map that is aligned with the wafer.

10. A process control monitor (PCM) cell comprising:
a first design for manufacturing (DFM) structure configured to detect a first direction of a first type of an overlay shift along a positive and negative x-direction or a positive and negative y-direction;
a second DFM structure configured to detect a second direction of a second type of the overlay shift along the positive and negative x-direction or the positive and negative y-direction; and
an output coupled to the first DFM structure and the second DFM structure and configured to indicate a direction and a type of the overlay shift, wherein the direction is the first direction or the second direction and the type of the overlay shift is the first type or the second type.

11. The PCM cell of claim 10, wherein the first DFM structure further comprises:
a first branch comprising a first transistor and a first switch, the first branch configured to measure a current-voltage characteristic in the positive x-direction;
a second branch comprising a second transistor and a second switch, the second branch configured to measure the current-voltage characteristic in the negative x-direction;
a third branch comprising a third transistor and a third switch, the third branch configured to measure the current-voltage characteristic in the positive y-direction;
a fourth branch comprising a fourth transistor and a fourth switch, the fourth branch configured to measure the current-voltage characteristic in the negative y-direction; and
a switch control configured to activate the first switch, the second switch, the third switch and the fourth switch to measure the current-voltage characteristic at the output, wherein a value of the current-voltage characteristic indicates an existence of the first type of the overlay shift and an activated switch indicates the first direction of the first type of the overlay shift.

12. The PCM cell of claim 11, wherein the switch control is further configured to activate the first switch, the second switch, the third switch, and the fourth switch sequentially.

13. The PCM cell of claim 11, wherein the first type of the overlay shift is a poly-to-contact overlay shift and a contact is a drain or source contact.

14. The PCM cell of claim 11, wherein each of the first transistor, the second transistor, the third transistor, and the fourth transistor are n-mos transistors.

15. The PCM cell of claim 10, wherein the second DFM structure further comprises:
a first branch comprising a first transistor and a first switch, the first branch configured to measure a current-voltage characteristic in the positive x-direction;
a second branch comprising a second transistor and a second switch, the second branch configured to measure the current-voltage characteristic in the negative x-direction;
a third branch comprising a third transistor and a third switch, the third branch configured to measure the current-voltage characteristic in the positive y-direction;
a fourth branch comprising a fourth transistor and a fourth switch, the fourth branch configured to measure the current-voltage characteristic in the negative y-direction; and
a switch control configured to activate the first switch, the second switch, the third switch and the fourth switch to measure the current-voltage characteristic at the output, wherein a value of the current-voltage characteristic indicates existence of the second type of the overlay shift and an activated switch indicates the second direction of the second type of the overlay shift.

16. The PCM cell of claim 15, wherein the switch control is further configured to activate the first switch, the second switch, the third switch, and the fourth switch sequentially.

17. The PCM cell of claim 15, wherein each of the first transistor, the second transistor, the third transistor, and the fourth transistor are n-mos transistors having corresponding drains connected to the output.

18. A method, comprising:
sequentially activating, using a first switch control coupled to a plurality of switches, a plurality of transistors in a first design for manufacturing DFM structure to detect a first type of an overlay shift along a positive x-direction and a negative x-direction, wherein the DFM structure is in a die of a wafer; and
determining an existence and direction of the first type of the overlay shift based on the sequentially activating the plurality of transistors.

19. The method of claim 18, wherein the plurality of transistors comprise:
a first transistor coupled to a first switch and configured to generate a current-voltage characteristic corresponding to the positive x-direction of the first type of the overlay shift; and
a second transistor coupled to a second switch and configured to generate the current-voltage characteristic corresponding to a negative x-direction of the first type of the overlay shift; and
the sequentially activating further comprises sequentially activating the first switch followed by the second switch.

20. The method of claim 18, further comprising:
sequentially activating, using a second switch control coupled to a second plurality of switches, a second plurality of transistors in a second DFM structure to detect a second type of the overlay shift along the positive x-direction and the negative x-direction, wherein the second DFM structure is in the die of the wafer; and
determining an existence and direction of the second type of the overlay shift based on the sequentially activating the second plurality of transistors.
